(19) United States
(12) Patent Application Publication
(10) Pub. No.: US 2020/0223180 A1
(43) Pub. Date: Jul. 16, 2020

(54) STAIN-RESISTANT FILM

(71) Applicant: Madico, Inc., Woburn, MA (US)

(72) Inventors: Lance Cullen, Woburn, MA (US); Tim Glowik, Woburn, MA (US)

(21) Appl. No.: 16/244,515

(22) Filed: Jan. 10, 2019

(51) Int. Cl. B32B 7/12; B32B 27/08; B32B 27/16; B32B 27/18; B32B 27/40; C09J 7/38; C09J 7/40

(52) U.S. Cl. CPC B32B 7/12; B32B 27/08; B32B 27/16; B32B 27/18; B32B 27/40; B32B 2375/00; C09J 7/385; C09J 7/405; B32B 2264/102; B32B 2307/748; B32B 2310/0831; C09J 7/383

(57) ABSTRACT

Protective films, uses thereof, and ways of making such films are provided, where the protective films provide improved stain resistance in protecting a painted surface. Such protective films can include a first layer and a second layer. The first layer can include a polyurethane acrylate and a silicone modified additive, where the first layer has a first face and a second face, and the first face has a first coating including silicone. The second layer can include a thermoplastic polyurethane that can be based on polycaprolactone, where the second layer has a first face and a second face, the first face of the second layer contacts the second face of the first layer, and the second face has a second coating that includes a pressure sensitive adhesive.

### FIELD

The present technology relates to stain-resistant films and methods of manufacturing stain-resistant films.

### INTRODUCTION

This section provides background information related to the present disclosure which is not necessarily prior art.

Various films are used to protect finishes of various surfaces, including various painted surfaces. Paint protection films can include a polyurethane film applied to a painted surface of a vehicle in order to protect the paint from light road debris, including stone chips, insects, and minor abrasions. Use of protective films is different from various paint sealants that are usually in liquid form and are designed for UV and chemical resistance. Sealants can harden up a clear-coat on a painted surface, but are not designed to protect the painted surface from physical damage. For this reason, protective films can provide certain advantages in protecting and preserving the appearance of painted surfaces. Protective films can be used on the surfaces of various vehicles, including automobiles, recreational vehicles, motorcycles, aircraft, and watercraft, and can be used on various consumer goods, including consumer electronics, such as mobile phones, screens, and other surfaces. Various types of paint protection films can be applied during assembly of such vehicles by original equipment manufacturers.

Protective films can be conformable to various surface contours, can be optically clear, and can be manufactured in a variety of thicknesses, as measured in mil in the US, where 1 mil is one thousandth of an inch. Examples of protective films further include films that are tinted or manufactured in a variety of colors. Various films can be multilayered and can include a top layer that is resistant to being scuffed or scratched. Certain films can include a slip solution or gel as a barrier that keeps the film from permanently adhering to the painted surface to which it is applied. Application of such films to surfaces can include the use of steam, heat guns, and/or torches to modify the pliability and aid in stretching of the film when conforming to complex surface shapes. Various films can be provided in pre-stretch and pre-form configurations as well for surfaces having complex wraps and curves.

Various protective films can include one or more polyurethane layers to provide resistance to environmental weathering, chemical exposure, heat, and abrasion. Films including polyurethanes can be generally optically transparent and can be used to protect painted surfaces, including both interior and exterior applications. Polyurethane films can also be used to cover and protect a surface having indicia or other decorative features thereon. Such decorative articles may also have interior as well as exterior uses. Desirable properties for protective films having a polyurethane layer include optimizations or improvements related to optical transparency, flexibility, weatherability, heat resistance, chemical resistance, solvent resistance, water resistance, and/or abrasion resistance. It is also preferable that the protective film can be tinted or colored without substantially impairing other desirable properties of the protective film.

### SUMMARY

The present technology includes articles of manufacture, systems, and processes that relate to stain-resistant films for protecting various surfaces, including painted surfaces.

Protective films and ways of manufacturing such films are provided where the protective film includes a first layer and a second layer. The first layer includes a polyurethane acrylate and can include a silicone modified additive. The first layer has a first face and a second face where the first face has a first coating including silicone. The second layer includes a thermoplastic polyurethane that can be based on polycaprolactone. The second layer has a first face and a second face where the first face of the second layer is adjacent the second face of the first layer and the second face has a second coating including a pressure sensitive adhesive. The first face of the second layer can also contact the second face of the first layer. The polyurethane acrylate can be based on a member of a group consisting of a polyester, a polycarbonate, and a combination thereof and the polyurethane acrylate can be based on one or more organic units (e.g., polyester, polycarbonate) including two, three, or four acrylate functionalities that subsequently polymerize to form the polyurethane acrylate. The polyurethane acrylate can further be based upon one or more members of a group consisting of a polyester, a polycarbonate, and a combination thereof, where each member includes two, three, or four acrylate functionalities that subsequently polymerize to form the polyurethane acrylate. The polyurethane acrylate can be fluorinated, thereby improving stain-resistance in certain embodiments. The protective film can also include a cap sheet adjacent the first face of the first layer, where the cap sheet provides the first coating including silicone on the first face of the first layer. Moreover, the protective film can include a release liner adjacent the second face of the second layer, where the release liner contacts the second coating including the pressure sensitive adhesive on the second face of the second layer.

Methods of making such protective films are provided that include application of the first layer to the second layer, application of the cap sheet to the first layer, and polymerizing or curing the applied first layer. In this way, silicone compounds from the first coating provided by the cap sheet can release therefrom and bond at least partially to the first layer, especially when the first layer includes a silicone modified additive. The result is an improved hydrophobicity/oleophobicity of the first layer once the cap sheet is removed, thereby conferring improved stain-resistance to the protective film.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of an embodiment of a protective film before application to a surface.

FIG. 2 is a cross-sectional view of the protective film of FIG. 1 after application to the surface.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to protective films that include multiple layers, ways of making protective films, and uses of protective films. Embodiments include protective films having a first layer that includes a polyurethane acrylate. The first layer has a first face and a second face, where the first face has a first coating including silicone. A second layer includes a thermoplastic polyurethane. The second layer has a first face and a second face, where the first face of the second layer is adjacent the second face of the first layer. The second face has a second coating including a pressure sensitive adhesive. Such protective films are stain-resistant and can be applied to various surfaces, including surfaces on vehicles, to protect painted surfaces. The multilayer protective film can be backed by a pressure sensitive adhesive and can have a silicone layer on top of the first layer (e.g., a thermoset polyurethane acrylate layer) that can be on top of the second layer (e.g., a thermoplastic polyurethane layer). Various surfaces to which the protective film is applied are part of the present technology, including surfaces of a vehicle, or a body portion thereof. Also included are methods for making such multilayer protective films.

It has surprisingly been found that a silicone can be transferred from the first layer following application of a cap sheet to the first layer, where the cap sheet has a coating that contacts the first layer and the coating includes the silicone compound. Without being bound by theory, it is believed that the silicone provided in the coating from the cap sheet can interact with a silicone modified additive in the first layer. This interaction can result in at least a portion of the silicone being transferred from the coating and remaining bonded or adsorbed to the first layer. The addition of the silicone to the cap sheet face, following removal of the cap sheet, provides the first layer with improved stain resistance. It is to be noted that reference to the silicone in the coating provided by the cap sheet includes various silicone compounds, also known as polymerized siloxanes or polysiloxanes that can have various organic side groups attached to silicon atoms that are part of a silicon-oxygen chain. Polydimethylsiloxane is one example of a silicone, where various modified and functionalized derivatives of polydimethylsiloxane are known.

The first layer can include a polyurethane compound, including a polyurethane acrylate (e.g., a polyurethane that was functionalized with one or more acrylate groups). The polyurethane can be based on a polyester and/or a polycarbonate that can further include one or more acrylate groups. As such, the polyurethane can be the result of polyester and/or polycarbonate units having from two to four functional acrylate groups that is polymerized (e.g., UV cured) to form the polyurethane acrylate material. To optimize properties, mixing of urethane precursor compounds (e.g., polyester and/or polycarbonates) having two acrylate functional groups with urethane precursor compounds (e.g., polyester and/or polycarbonates) having three or four functional groups can be employed in order to tailor the polymerization of the polyurethane acrylates and optimize the amount of chain extension, cross-linking, and thermoset properties of the resulting polyurethane acrylate. Examples of urethane precursor acrylates that can be used include those commercially available as Sartomer CN9001 (2 functional, polyester based urethane oligomer) and Sartomer CN9030 (2 functional, polycarbonate based urethane oligomer) available from Sartomer USA (Exton, Pa.). Fluorinated versions of such urethane acrylates can also be employed to increase stain resistance and increase hydrophobicity through the life of the layer and film. The layer can contain one or more photoinitiator types so that once exposed to UV energy, free radicals are created, and polymerization occurs. Photoinitiator examples that can be used alone or in combination are Speed Cure 84, Darocur 1173, and Esacure KIP 100 F. The layer can include a small percentage of a silicone modified additive in the amount of 0.2%-1.5% as a percent of total solids. This silicone modified additive has unexpectedly been shown to bond to the silicone from the coating on the cap sheet that is applied to the first layer. Once the cap sheet is removed from the protective film, a portion of the silicone from the coating of the cap sheet remains adhered to the first layer, thereby substantially increasing the resulting stain resistance of the protective film. An example of the silicone modified additive includes multi-acrylic functional, modified polydimethylsiloxane, where commercial examples are available as BYK-UV 3505 from BYK-Chemie GmbH (Wesel, Germany) and DMS-R11 and DMS-U21 from Gelest. Organic solvents such as methyl ethyl ketone (MEK) or ethyl acetate can be used to dilute a coating forming the first layer to a viscosity that is optimized for coating and forming the first layer without defects, typically around 30% solids. Ultraviolet absorbers (UV-absorbers or UVA) and/or hindered amine light stabilizers (HALS) can also be added alone or in combination to further enhance the stability of the first layer in an outdoor environment.

The second layer includes a thermoplastic polyurethane that can be based on polycaprolactone. The thermoplastic polyurethane can also include various thermoplastic elastomers formed of linear segmented block copolymers composed of hard and soft segments, including various various aliphatic polyesters. Various polyester and polyether based thermoplastic polyurethanes can be used alone or in combination.

The pressure sensitive adhesive can be applied to the second layer in various ways, including various coating methods including spraying, roll coating, or calendaring. The pressure sensitive adhesive can also be transferred to the second layer from a release liner having a coating of the pressure sensitive adhesive. Examples of pressure sensitive adhesives include various hot melts, emulsion, and solvent-based adhesives that can be formulated from natural rubber, certain synthetic rubbers, and polyacrylates. Pressure sensitive adhesives can be supplied dissolved in organic solvents, as an aqueous dispersion, as a UV-curable, as a hot melt, or coated on the second layer or the release liner. Liquid applied (e.g., solvent or water based, hot melt, UV-curable) pressure sensitive adhesives can be applied in bead or ribbon, sprayed, or roll coated. After coating, and drying or UV curing of solvent or water based or UV-curable systems, the pressure sensitive adhesive can remain covered with the release liner, which is later removed for bonding to a surface to which the protective film is to be applied.

Rubber, acrylic, and silicone-based pressure sensitive adhesives can be used. Rubber, acrylic, and silicone-based pressure sensitive adhesives can perform differently due to their chemical nature. Rubber adhesives can provide excellent tack and high initial adhesion, high affinity to low surface energy substrates, such as polyethylene and polypropylene, poor to fair UV resistance, and tend to be yellow color. Acrylic adhesives can provide excellent weatherability and good clarity, good solvent resistance, low initial adhesion that may build with time, good plasticizer resistance, and good convertability, where they are generally not as gummy as rubber-based adhesives. Silicone adhesives can provide higher temperature resistance (e.g., >400 degrees F.), low peels, and high shear.

The protective film can include a cap sheet adjacent the first face of the first layer, where the cap sheet provides the first coating including silicone on the first face of the first layer. Examples of cap sheet materials include silicone coated films of polyethylene, polypropylene, polyester, and polystyrene. Further examples of cap sheet materials include silicone coated papers, including silicone coated kraft paper. Still further examples of cap sheet materials include film constructs formed of polyolefin extruded onto both sides of a polyethylene terephthalate film and silicone coated on at least one face. The cap sheet can preserve, maintain, and provide the first coating including silicone on the first face of the first layer of the protective film. The cap sheet can also aid in the manufacture and storage of the protective film by covering, contacting, and protecting the pressure sensitive film until the protective film is to be used. For example, the cap sheet allows the protective film to be folded back upon itself, stacked, or wound upon a roll while preserving the first face of the first layer up to the point of surface application. Handling of the protective film is also improved, including processing and manipulation of the protective film, including winding/unwinding and cutting steps to which the protective film is subjected.

The protective film can include various types of a release liner adjacent the second face of the second layer, where the release liner contacts the second coating including the pressure sensitive adhesive on the second face of the second layer. Examples of release liner materials include the examples of materials as described herein for the cap sheet materials. However, while the release liner can provide a silicone coating, the release liner does not necessarily have a silicone coating applied thereto. The release liner, however, is configured to have reduced adhesive force with the pressure sensitive adhesive as compared to the adhesive force between the pressure sensitive adhesive and the second layer. In this way, the release liner can be separated from the second layer including the pressure sensitive adhesive, leaving the pressure sensitive adhesive on the second face of the second layer for application of the protective film to the desired surface; e.g., a painted surface. The release liner can also aid in the manufacture and storage of the protective film by covering, contacting, and protecting the pressure sensitive adhesive until the protective film is to be used. For example, the release liner allows the protective film to be folded back upon itself, stacked, or wound upon a roll while preserving the functional character of the pressure sensitive adhesive up to the point of surface application. Handling of the protective film is also improved, including processing and manipulation of the protective film, including winding/unwinding and cutting steps to which the protective film is subjected.

Various processes can be used to form the protective sheet. Embodiments include where the pressure sensitive adhesive is coated or applied to the second layer. For example, the second layer including the thermoplastic polyurethane can originally be provided as a layer having an original protective covering, like the cap sheet or release layer described herein, where the pressure sensitive adhesive is applied to the side of the second layer opposite the original protective covering. The original protective covering can be removed from the second layer and a coating that will form the first layer can be applied to the side formerly having the original protective covering. The coating that will form the first layer can be dried to remove solvent including organic or aqueous solvent(s). The coating that will form the first layer can be cured before or after the cap sheet providing the coating including silicone is overlaid or laminated thereon. Curing can be effected by ultraviolet light where the first layer includes one or more types of urethane precursor compounds including acrylate functional groups, for example, to form the polyurethane acrylate. The resulting first layer can be tailored to have a smooth and glossy surface or a matte surface that when the protective film is installed in a paint protection application is highly stain resistant, can self-heal at room temperature, and can elongate by 90% or more before any cracking or splitting occurs. A smooth and glossy surface can be attained with the use of a smooth, glossy, low haze cap sheet providing the first coating including silicone; e.g., a cap sheet of polyester film as per Mitsubishi 74SLK (Greer, S.C.), Mitsubishi 4365NK or Toray XG7BR. Similarly, a matte surface can be attained with the use of a matte cap sheet providing the first coating including silicone; e.g., Melinex 377 by Tekra (New Berlin, Wis.).

Methods of making the protective sheet can further include the following steps: applying a first layer to a second layer; applying a cap sheet to the first layer; and curing the applied first layer. In consideration of these steps, the first layer can include a polyurethane acrylate and a silicone modified additive, where the first layer has a first face and a second face. The first face accordingly has a first coating including silicone following the step of applying the cap sheet to the first layer. The second layer can include a thermoplastic polyurethane based on polycaprolactone, where the second layer has a first face and a second face. The first face of the second layer can contact the second face of the first layer following the step of applying the first layer to the second layer. The second face of the second layer can have a second coating including a pressure sensitive adhesive. A cap sheet can be adjacent the first face of the first layer, where the cap sheet provides the first coating including silicone on the first face of the first layer following the step of applying the cap sheet to the first layer. Curing the applied first layer can include applying ultraviolet light, for example, where the first layer can include one or more organic units (e.g., polyester, polycarbonate) including acrylate functionalities that subsequently polymerize to form the polyurethane acrylate. Methods can further include applying a release liner adjacent the second face of the the second layer, where the release liner contacts the second coating including the pressure sensitive adhesive on the second face of the second layer.

The use of a plain polyester film as a cap sheet in the UV curing process was initially utilized to compensate for oxygen inhibition to allow for a reasonable speed of crosslinking with existing equipment, a well known alternative to nitrogen inerting. In experimenting with cap sheets and testing the ease of removing the cap sheet, the unexpected result of silicone transfer from the cap sheet (having a coating including silicone) to the first layer was observed and the subsequent effect on stain resistance was discovered. When a cap sheet providing a first coating including silicone is overlaid onto the first layer, where the first coating contacts the first face of the first layer, at least a portion of the silicone was observed to release from the cap sheet and bond at least partially to the first layer. This is evidenced by the increased hydrophobicity/oleophobicity of the first face of the first layer once the cap sheet is removed. It was observed that this increased hydrophobicity/oleophobicity does not occur if: (1) a cap sheet of plain polyester film is used in place of a cap sheet having a coating including silicone; and (2) the silicone modified additive is not present in the first layer.

### Example

An example embodiment of the present technology is provided with reference to the figures enclosed herewith.

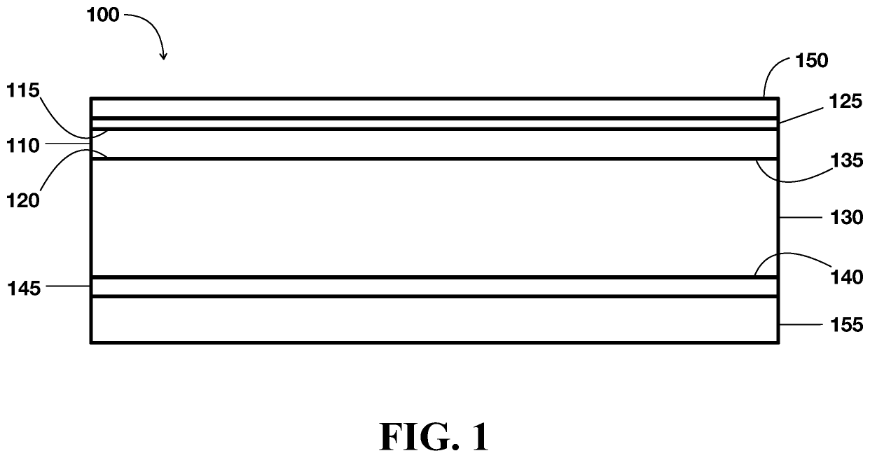

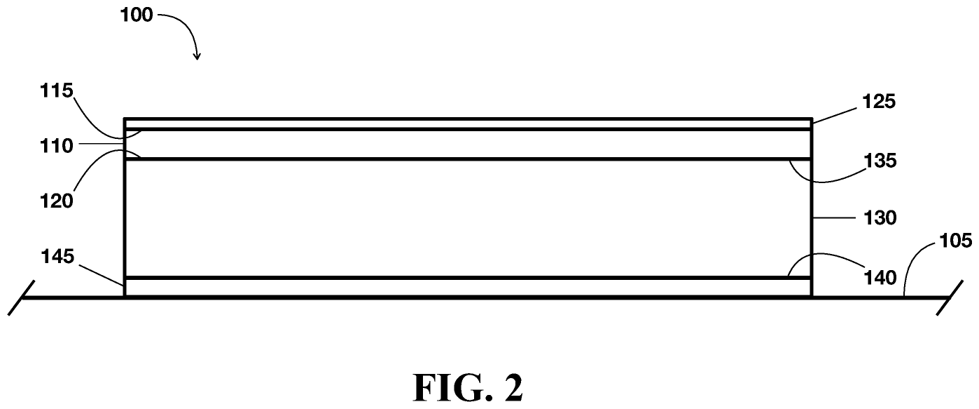

With reference to the figures, an embodiment of a protective film 100 prior to installation on a surface 105 (FIG. 1) and following installation on a surface 105 (FIG. 2) is shown.

The protective film 100 includes a first layer 110 including a polyurethane acrylate. The first layer 110 has a first face 115 and a second face 120, where the first face 115 has a first coating 125 including silicone. A second layer 130 includes a thermoplastic polyurethane. The second layer 130 has a first face 135 and a second face 140, where the first face 135 of the second layer 130 is adjacent the second face 120 of the first layer 110 and the second face 140 of the second layer 130 has a second coating 145 thereon that includes a pressure sensitive adhesive. As can be seen the embodiment of the protective film 100 depicted in the figures, the first face 135 of the second layer 130 contacts the second face 120 of the first layer 110. A cap sheet 150 is adjacent the first face 115 of the first layer 110, where the cap sheet 150 can provide the first coating 125 including silicone on the first face 115 of the first layer 110. The protective film 100 also includes a release liner 155 adjacent the second face 140 of the second layer 130, where the release liner 155 contacts the second coating 145 including the pressure sensitive adhesive on the second face 140 of the second layer 130.

Prior to installation of the protective film 100 onto the surface 105, the release liner 155 is removed to expose the second coating 145 including the pressure sensitive adhesive on the second face 140 of the second layer 130. The second coating 145 including the pressure sensitive adhesive can then be placed in contact with the surface 105. Prior to installation or after installation, the cap sheet 150 can be removed from the protective film 100 leaving at least a portion of the silicone from the first coating 125 on the first face 115 of the first layer 110. This results in the first face 115 of the first coating 110 exhibiting optimized stain resistance. The surface 105 onto which the protective film is applied can be a painted surface.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A protective film comprising:
a first layer including a polyurethane acrylate, the first layer having a first face and a second face, the first face having a first coating including silicone; and
a second layer including a thermoplastic polyurethane, the second layer having a first face and a second face, the first face of the second layer adjacent the second face of the first layer, the second face having a second coating including a pressure sensitive adhesive.

2. The protective film of claim 1, wherein the first face of the second layer contacts the second face of the first layer.

3. The protective film of claim 1, wherein the polyurethane acrylate is based on a member of a group consisting of a polyester, a polycarbonate, and a combination thereof.

4. The protective film of claim 1, wherein the polyurethane acrylate is based on a member of a group consisting of a polyester, a polycarbonate, and a combination thereof, where the member includes two, three, or four acrylate functionalities that subsequently polymerize to form the polyurethane acrylate.

5. The protective film of claim 4, wherein the polyurethane acrylate is based on a plurality of members of a group consisting of a polyester, a polycarbonate, and a combination thereof, where each member includes two, three, or four acrylate functionalities that subsequently polymerize to form the polyurethane acrylate.

6. The protective film of claim 1, wherein the polyurethane acrylate is fluorinated.

7. The protective film of claim 1, wherein the first layer includes a photoinitiator.

8. The protective film of claim 1, wherein the first layer includes a silicone modified additive.

9. The protective film of claim 8, wherein the silicone modified additive includes an acrylated polydimethylsiloxane.

10. The protective film of claim 1, wherein the first layer includes a member of a group consisting of an ultraviolet absorber, a hindered amine light stabilizer, and a combination thereof.

11. The protective film of claim 1, wherein the thermoplastic polyurethane is based on polycaprolactone.

12. The protective film of claim 1, wherein the pressure sensitive adhesive includes a member selected from a group consisting of rubber, acrylic, silicone, and combinations thereof.

13. The protective film of claim 1, further comprising a cap sheet adjacent the first face of the first layer, the cap sheet providing the first coating including silicone on the first face of the first layer.

14. The protective film of claim 1, further comprising a release liner adjacent to the second face of the second layer, the release liner contacting the second coating including the pressure sensitive adhesive on the second face of the second layer.

15. A surface having a protective film according to claim 1 applied thereto, wherein the surface is contacted with the coating including the pressure sensitive adhesive from the second face of the second layer.

16. The surface of claim 15, wherein the surface includes a painted surface.

17. A protective film comprising:
a cap sheet having a first coating disposed thereon, the first coating including silicone;
a first layer including a polyurethane acrylate and a silicone modified additive, the first layer having a first face and a second face, the first face contacting the first coating including silicone;
a second layer including a thermoplastic polyurethane based on polycaprolactone, the second layer having a first face and a second face, the first face of the second layer contacting the second face of the first layer, the second face having a second coating including a pressure sensitive adhesive; and
a release liner adjacent the second face of the second layer, the release liner contacting the second coating including the pressure sensitive adhesive on the second face of the second layer.

18. A method of making a protective film comprising:
applying a first layer to a second layer;
applying a cap sheet to the first layer; and
curing the applied first layer;
wherein:
the first layer includes a polyurethane acrylate and a silicone modified additive, the first layer having a first face and a second face, the first face having a first coating including silicone following the step of applying the cap sheet to the first layer;
the second layer including a thermoplastic polyurethane based on polycaprolactone, the second layer having a first face and a second face, the first face of the second layer contacting the second face of the first layer following the step of applying the first layer to the second layer, the second face having a second coating including a pressure sensitive adhesive; and
a cap sheet adjacent the first face of the first layer, the cap sheet providing the first coating including silicone on the first face of the first layer following the step of applying the cap sheet to the first layer.

19. The method of claim 19, wherein curing the applied first layer includes applying ultraviolet light.

20. The method of claim 19, further comprising applying a release liner adjacent the second face of the second layer, the release liner contacting the second coating including the pressure sensitive adhesive on the second face of the second layer.
